(19) United States
(12) Patent Application Publication
(10) Pub. No.: US 2025/0357675 A1
(43) Pub. Date: Nov. 20, 2025

(54) RADIO WAVE CONTROL PLATE AND COMMUNICATION SYSTEM

(71) Applicant: KYOCERA Corporation, Kyoto-shi, Kyoto (JP)

(72) Inventors: Nobuki HIRAMATSU, Yokohama-shi, Kanagawa (JP); Masamichi YONEHARA, Yokohama-shi, Kanagawa (JP); Kengo SUGIYAMA, Fujisawa-shi, Kanagawa (JP)

(21) Appl. No.: 18/867,565

(22) PCT Filed: May 19, 2023
(86) PCT No.: PCT/JP2023/018827

§ 371 Date: Nov. 20, 2024

(30) Foreign Application Priority Data
May 31, 2022 (JP) 2022-088914

(51) Int. Cl. H01Q 15/00; H01Q 15/02; H01Q 15/14

(52) U.S. Cl. CPC H01Q 15/0006; H01Q 15/02; H01Q 15/14

(57) ABSTRACT

A radio wave control plate is a radio wave control plate installed between a transmitter configured to transmit a radio wave and a receiver configured to receive the radio wave, and a length in a first direction parallel to a refraction surface or a reflection surface of the radio wave and/or a length in a second direction perpendicular to the first direction in the radio wave control plate is from 75% to 125% of twice a radius of a circular region defined according to a positional relationship between the transmitter, the radio wave control plate, and the receiver.

### TECHNICAL FIELD

The present disclosure relates to a radio wave control plate and a communication system.

### BACKGROUND OF INVENTION

A known technique involves controlling electromagnetic waves without using a dielectric lens. For example, Patent Document 1 describes a technique of refracting radio waves by changing parameters of respective elements in a structure including an array of resonator elements.

### CITATION LIST

### Patent Literature

Patent Document 1: JP 2015-231182 A

### SUMMARY

A radio wave control plate according to the present disclosure is a radio wave control plate installed between a transmitter configured to transmit a radio wave and a receiver configured to receive the radio wave, and a length in a first direction parallel to a refraction surface or a reflection surface of the radio wave and/or a length in a second direction perpendicular to the first direction in the radio wave control plate is from 75% to 125% of twice a radius of a circular region defined according to a positional relationship between the transmitter, the radio wave control plate, and the receiver.

A communication system according to the present disclosure includes: a transmitter configured to transmit a radio wave; a plurality of radio wave control plates configured to refract or reflect the radio wave transmitted from the transmitter; and a receiver configured to receive the radio wave refracted or reflected by the plurality of radio wave control plates, and a length in a first direction parallel to a refraction surface or a reflection surface of the radio wave and/or a length in a second direction perpendicular to the first direction in each of the plurality of radio wave control plates is from 75% to 125% of twice a radius of a circular region defined according to a positional relationship between the transmitter, the plurality of radio wave control plates, and the receiver.

### BRIEF DESCRIPTION OF THE DRAWINGS

FIG. 1 illustrates a configuration example of a communication system according to an embodiment.

FIG. 2 is a diagram schematically illustrating an example of a radio wave refraction plate.

FIG. 3 is a diagram for explaining that the radio wave refraction plate according to the present embodiment is installed.

FIG. 4 is a diagram for explaining an installation method of the radio wave refraction plate according to the first embodiment.

FIG. 5 is a diagram for explaining a relationship between the radio wave refraction plate and a Fresnel zone according to the first embodiment.

FIG. 6 is a diagram for explaining angular dependence of received power according to the first embodiment.

FIG. 7 is a diagram for explaining the relationship between the radio wave refraction plate and the Fresnel zone according to a second embodiment.

FIG. 8 is a diagram illustrating angular dependence of received power according to the second embodiment.

FIG. 9 is a diagram for explaining the relationship between the radio wave refraction plate and the Fresnel zone according to the third embodiment.

FIG. 10 is a diagram illustrating angular dependence of received power according to the third embodiment.

FIG. 11 is a diagram for explaining an installation method of a plurality of radio wave refraction plates according to a fourth embodiment.

FIG. 12 is a schematic diagram illustrating the plurality of radio wave refraction plates according to the fourth embodiment.

FIG. 13 is a diagram illustrating angular dependence of received power according to the fourth embodiment.

FIG. 14 is a diagram illustrating a relationship between gaps between the plurality of radio wave refraction plates and received power according to a fifth embodiment.

### DESCRIPTION OF EMBODIMENTS

In the following, embodiments of the present disclosure will be described in detail with reference to the accompanying drawings. The present invention is not limited by the embodiments, and in the following embodiments, the same reference signs are assigned to the same portions and redundant descriptions thereof will be omitted.

### Embodiment

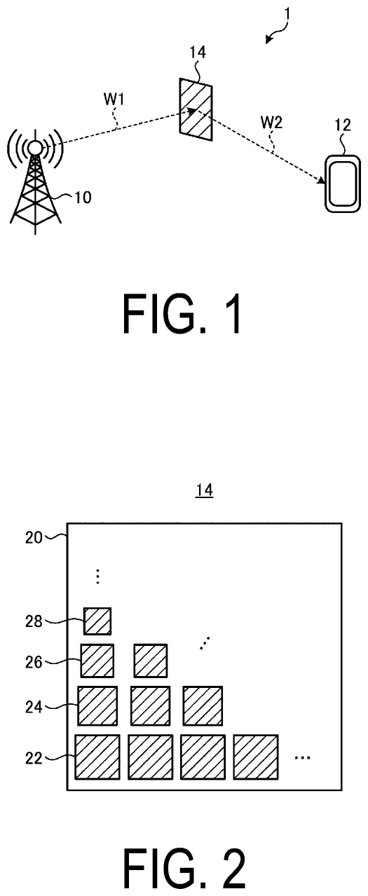

A configuration example of a communication system according to an embodiment is described with reference to FIG. 1. FIG. 1 illustrates a configuration example of a communication system according to the embodiment.

As illustrated in FIG. 1, a communication system 1 includes a base station 10, a terminal 12, and a radio wave refraction plate 14. The communication system 1 may be, for example, a communication system that can perform large-capacity data communication in high speed, such as the fifth generation mobile communication system (hereinafter, also referred to as the “5G”) or the sixth generation mobile communication system (hereinafter, also referred to as the “6G”).

The base station 10 is a wireless communication device configured to transmit and receive radio waves to and from various external devices. For example, the base station 10 is configured to wirelessly communicate with the terminal 12 by transmitting and receiving radio waves corresponding to the 5G or 6G to and from the terminal 12. In the present embodiment, the base station 10 is configured to wirelessly communicate with the terminal 12 via the plurality of radio wave refraction plates 14 installed on the same plane.

The terminal 12 is a wireless communication device configured to transmit and receive radio waves to and from various external devices. For example, the terminal 12 is configured to wirelessly communicate with the base station 10 by transmitting and receiving radio waves corresponding to the 5G or 6G to and from the base station 10. In the present embodiment, the terminal 12 is configured to wirelessly communicate with the base station 10 via the plurality of radio wave refraction plates 14 installed on the same plane. As the terminal 12, for example, a smartphone used by a user is exemplified, but the present disclosure is not limited thereto. For example, the terminal 12 may be a relay device that relays communication between the base station 10 and a smartphone used by a user.

The radio wave refraction plates 14 are plate-shaped members configured to be permeable to the radio waves transmitted from the base station 10. For example, the radio wave refraction plates 14 are configured to refract the radio wave at a predetermined angle and emit a refracted radio wave upon receipt of the radio wave transmitted from the base station 10. Specifically, upon receipt of the radio wave transmitted from the base station 10, the radio wave refraction plates 14 are configured to refract the radio wave in a direction of the terminal 12 and emit the radio wave toward the terminal 12. The radio wave refraction plates 14 may be made of, for example, a metamaterial that changes a phase of an incident wave.

FIG. 2 is a diagram schematically illustrating an example of a radio wave refraction plate 14. As illustrated in FIG. 2, the radio wave refraction plate 14 may include a substrate 20 and elements 22, 24, 26, and 28, for example.

The elements 22, the elements 24, the elements 26, and the elements 28 may be formed on the substrate 20. The substrate 20 may have a rectangular shape, for example, but is not limited thereto. The elements 22, 24, 26, and 28 may be two-dimensionally arranged on the substrate 20. Specifically, in FIG. 2, a plurality of elements 22 may be arranged in a line in the bottom row of the substrate 20. On the substrate 20, a plurality of elements 24 may be arranged in a line in a row above the row where the elements 22 are arranged. On the substrate 20, a plurality of elements 26 may be arranged in a line in a row above the row where the elements 24 are arranged. On the substrate 20, a plurality of elements 28 may be arranged in a line in a row above the row where the elements 26 are arranged. That is, the radio wave refraction plate 14 may have a structure in which a plurality of elements having different sizes are periodically arranged. The elements 22 to 28 may be different in the frequency band of the radio wave to be changed and the amount of change in the phase. The elements 22 to 28 have the rectangular shapes, without limitation. A frequency band and a phase change amount of the radio wave to be refracted can be adjusted by changing the sizes and shapes of the element 22, the element 24, the element 26, and the element 28.

The present embodiment will be described assuming that the communication system 1 includes the radio wave refraction plate 14 that refract radio wave. However, the present disclosure is not limited thereto. Instead of the radio wave refraction plate 14, the communication system 1 may include a radio wave refraction plate that, when receiving a radio wave transmitted by the base station 10, reflects this radio wave at a predetermined angle and emits the reflected radio wave. The radio wave refraction plates and the radio wave reflection plates are a kind of radio wave control plates.

### First Embodiment

### Installation Method of Radio Wave Refraction Plate

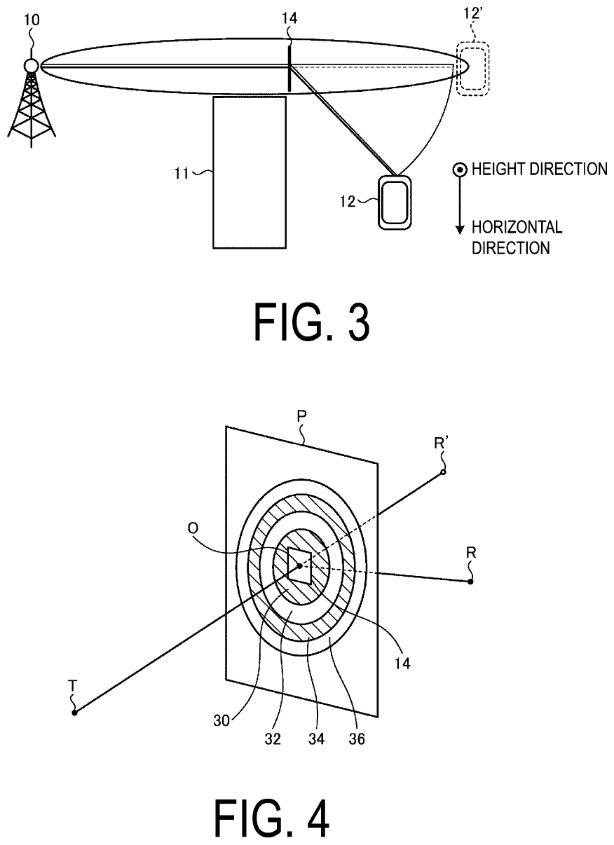

An installation method of the radio wave refraction plate according to the first embodiment will be described. FIG. 3 is a diagram for explaining that the radio wave refraction plate according to the first embodiment is installed. FIG. 3 is a schematic diagram illustrating from above that the radio wave refraction plate 14 is installed. As illustrated in FIG. 3, the radio wave refraction plate 14 is installed near an obstacle 11 that may be an obstacle for radio waves between the base station 10 and the terminal 12, and at a position at which the base station 10 and the terminal 12 can be seen. In the first embodiment, the radio wave refraction plate 14 is installed in a region defined based on a positional relationship between the base station 10, the terminal 12, and the radio wave refraction plate 14. More specifically, the radio wave refraction plate 14 is installed in a Fresnel zone defined based on a linear distance between the base station 10 and the radio wave refraction plate 14 and a linear distance between the terminal 12 and the radio wave refraction plate 14. Note that, in FIG. 3, a terminal 12′ indicates the virtual terminal 12 located on an extended line of a straight line that connects the base station 10 and the radio wave refraction plate 14. The linear distance between the terminal 12 and the radio wave refraction plate 14 and the linear distance between the terminal 12′ and the radio wave refraction plate 14 are the same. In the example illustrated in FIG. 3, when the terminal 12 is located on an arc between the terminal 12 and the terminal 12′, the linear distance between the terminal 12 and the radio wave refraction plate 14 does not change.

### Fresnel Zone

A definition of a Fresnel zone according to the first embodiment will be described. FIG. 4 is a diagram for explaining an installation method of the radio wave refraction plates according to the first embodiment. A transmission point T indicates a position of an antenna of the base station 10 illustrated in FIG. 3. A reception point R indicates a position of an antenna of the terminal 12 illustrated in FIG. 3. A reception point R′ indicates the position of the antenna of the virtual terminal 12 illustrated in FIG. 3. A center point O indicates a center point of the radio wave refraction plate 14. That is, in the example illustrated in FIG. 4, a linear distance between the center point O and the reception point R and a linear distance between the center point O and the reception point R′ are the same. In the first embodiment, given a path of the radio wave that reaches the reception point R from the transmission point T passing through a point on the radio wave refraction plate 14, the radio wave refraction plate 14 is installed in a region in which radio waves strengthen each other. Thus, the present embodiment can obtain higher received power. In the present embodiment, a region in which radio waves strengthen each other is referred to as an odd-order Fresnel zone, and a region in which radio waves weaken each other is referred to as an even-order Fresnel zone.

As illustrated in FIG. 4, a situation is considered that a radio wave from the transmission point T passes through the radio wave refraction plate 14 and reaches the reception point R. In FIG. 4, a center point of the radio wave refraction plate 14 is the center point O. A linear distance between the transmission point T and the center point O is set as d_{TX}. A linear distance between the reception point R and the center point O is set as d_{RX}. A plane P perpendicular to a straight line that connects the transmission point T and the reception point R′ through the center point O. Here, a circle centered about the center point O and having the radius defined by following Equation (1) on the plane P is considered.

$$\begin{matrix}[ Math 1 ] & \\ {r}_{n} = \sqrt{n \frac{λ {d}_{TX} {d}_{RX}}{{d}_{TX} + {d}_{RX}}} & ( 1 )\end{matrix}$$

In Equation (1), n is a natural number, and λ is a wavelength of the radio wave.

In the present embodiment, in Equation (1), an annular portion in a range from a radius rₙ₋₁ to a radius In is defined as an n-th Fresnel zone. The example illustrated in FIG. 3 includes a first Fresnel zone 30, a second Fresnel zone 32, a third Fresnel zone 34, and a fourth Fresnel zone 36.

### (Radio Wave Refraction Plate and Fresnel Zones)

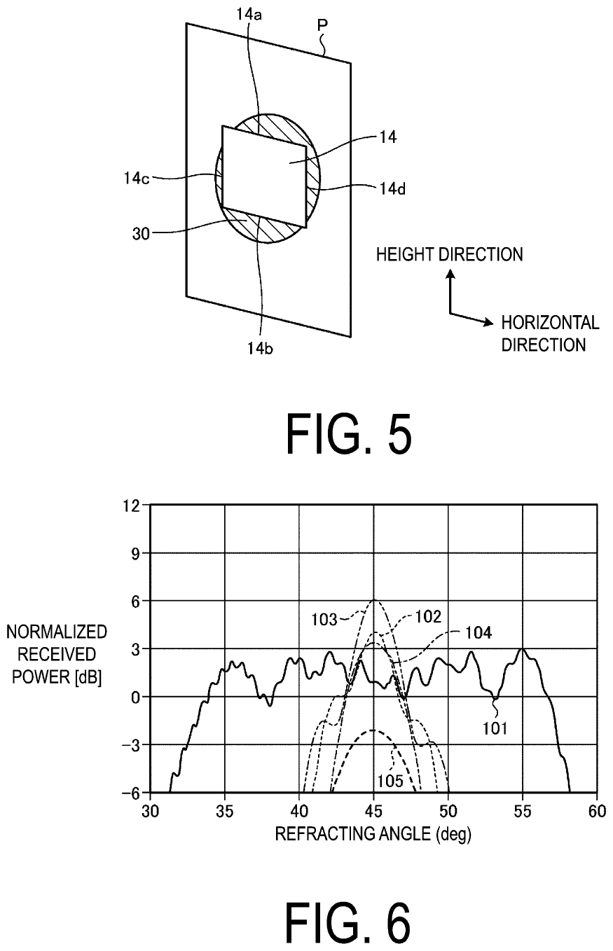

A relationship between the radio wave refraction plate and the Fresnel zones according to the first embodiment will be described with reference to FIG. 5. FIG. 5 is a diagram for explaining the relationship between the radio wave refraction plate and the Fresnel zones according to the first embodiment.

As illustrated in FIG. 5, in the first embodiment, a length a between an upper side 14a and a lower side 14b that are sides (sides in a horizontal direction) parallel to a refraction surface (plane P) of the radio wave refraction plate 14 is formed in a range of a length that is the two-fold radius of the first Fresnel zone 30 ±25%. In other words, the length between the upper side 14a and the lower side 14b is preferably formed as the length in the range from 75% to 125% of the length of twice the radius of the first Fresnel zone 30. When the radio wave refraction plate 14 is formed in this range, received power can be improved. In the example illustrated in FIG. 5, a length between a left side 14c and a right side 14d may be arbitrary.

FIG. 6 is a diagram illustrating angular dependence of received power according to the first embodiment. FIG. 6 illustrates the angular dependence of the received power that depends on a difference in the size (the length in the height direction×the length in the horizontal direction) of the radio wave refraction plate 14.

It is assumed in the example illustrated in FIG. 6 that a linear distance between the transmission point of the radio wave and the radio wave refraction plate 14 is 50 m, a linear distance between the reception point of the radio wave and the radio wave refraction plate 14 is 2 m, and the frequency of the radio waves is 28 [GHz (gigahertz)]. In this case, the radius of the first Fresnel zone 30 is 0.14 [m]. The received power is normalized as the received power when the radio wave refraction plate 14 is not installed.

FIG. 6 illustrates a waveform 101, a waveform 102, a waveform 103, a waveform 104, and a waveform 105. The waveform 101 indicates angular dependence of received power of the radio wave refraction plate 14 of 1.15 m×1.2 m. The waveform 102 indicates angular dependence of received power of the radio wave refraction plate 14 of 0.33 m×0.36 m. The waveform 103 indicates angular dependence of the received power of the radio wave refraction plate 14 of 0.27 m×0.3 m. The waveform 104 indicates angular dependence of received power of the radio wave refraction plate 14 of 0.19 m×0.22 m. The waveform 105 indicates angular dependence of received power of the radio wave refraction plate 14 of 0.13 m×0.16 m.

The waveform 102 indicates the angular dependence of the received power of the radio wave refraction plate 14 whose length in the horizontal direction is approximately the two-fold radius of the first Fresnel zone 30 +25%. The waveform 103 indicates the angular dependence of the received power of the radio wave refraction plate 14 whose length in the horizontal direction is approximately twice the radius of the first Fresnel zone 30. The waveform 104 indicates the angular dependence of the received power of the radio wave refraction plate 14 whose length in the horizontal direction is approximately the two-fold radius of the first Fresnel zone 30 −25%. The waveform 102, the waveform 103, and the waveform 104 indicate good characteristics since the normalized received power of a peak at 45° of the refracting angle is 3 [dB] or more. That is, in the first embodiment, by setting the length in the horizontal direction of the radio wave refraction plate 14 within a range of +25% of approximately the two-fold radius of the first Fresnel zone 30, received power can be improved.

### Second Embodiment

### Radio Wave Refraction Plate and Fresnel Zones

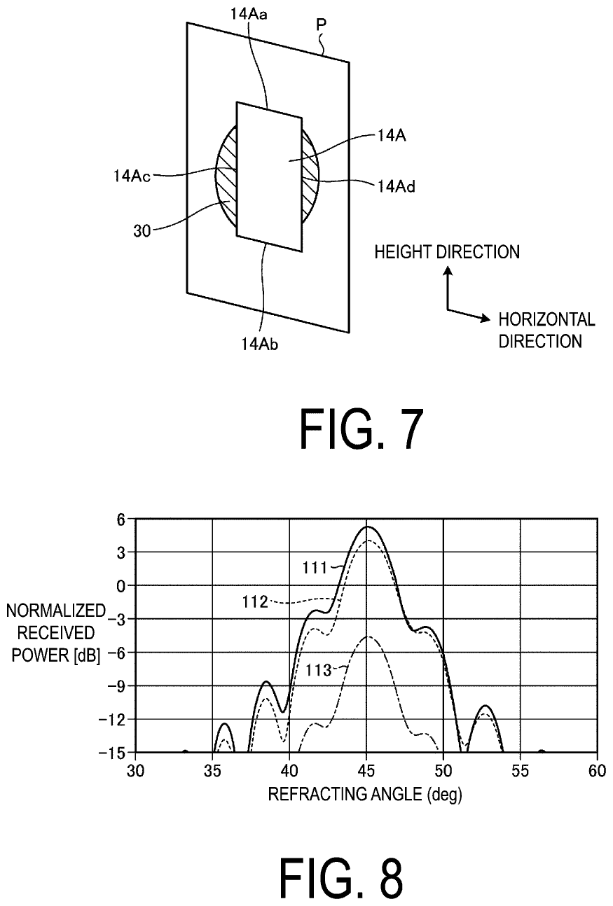

A relationship between the radio wave refraction plate and the Fresnel Zones according to the second embodiment will be described with reference to FIG. 7. FIG. 7 is a diagram for explaining the relationship between the radio wave refraction plate and the Fresnel zones according to the second embodiment.

As illustrated in FIG. 7, in the second embodiment, when received power needs to be improved only in a certain height area, lengths of a left side 14Ac and a right side 14Ac that are the sides in the height direction of a radio wave refraction plate 14A are formed in a range of ±25% of the two-fold radius of the first Fresnel zone 30.

FIG. 8 is a diagram illustrating angular dependence of received power according to the second embodiment. FIG. 8 illustrates the angular dependence of the received power that depends on a difference in the size (the length in the height direction×the length in the horizontal direction) of the radio wave refraction plate 14A.

It is assumed in the example illustrated in FIG. 8 that a linear distance between the transmission point of the radio wave and the radio wave refraction plate 14A is 50 m, a linear distance between the reception point of the radio wave and the radio wave refraction plate 14A is 2 m, and the frequency of the radio waves is 28 [GHz]. In this case, the radius of the first Fresnel zone 30 is 0.14 [m]. The received power is normalized as the received power when the radio wave refraction plate 14A is not installed.

FIG. 8 illustrates a waveform 111, a waveform 112, and a waveform 113. The waveform 111 indicates angular dependence of received power of the radio wave refraction plate 14A of 0.3 m×0.3 m. The waveform 112 indicates angular dependence of received power of the radio wave refraction plate 14A of 0.6 m×0.3 m. The waveform 113 indicates angular dependence of received power of the radio wave refraction plate 14A of 0.05 m×0.3 m.

The waveform 111 indicates the angular dependence of the received power of the radio wave refraction plate 14A whose length in the height direction is approximately 4.2 times the radius of the first Fresnel zone 30. The waveform 112 indicates the angular dependence of the received power of the radio wave refraction plate 14A whose length in the horizontal direction is approximately twice the radius of the first Fresnel zone 30. The waveform 111 and the waveform 112 indicate good characteristics since the normalized received power of a peak at 45° of the refracting angle is 3 [dB] or more. Upon comparison between the waveform 111 and the waveform 112, the waveform 111 indicates better characteristics. That is, in the second embodiment, by setting the length in the height direction of the radio wave refraction plate 14A within a range of ±25% of approximately the two-fold radius of the first Fresnel zone 30, received power can be improved.

### Third Embodiment

### Radio Wave Refraction Plate and Fresnel Zones

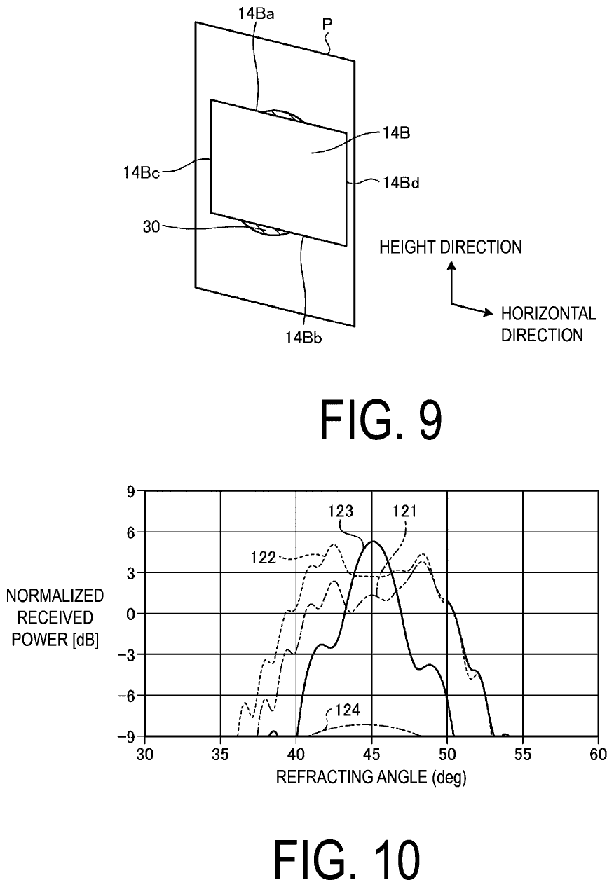

A relationship between the radio wave refraction plate and the Fresnel Zones according to the third embodiment will be described with reference to FIG. 9. FIG. 9 is a diagram for explaining the relationship between the radio wave refraction plate and the Fresnel zones according to the third embodiment.

As illustrated in FIG. 9, in the third embodiment, the lengths of a left side 14Bc and a right side 14Bd that are the sides in the height direction of a radio wave refraction plate 14B are twice the radius of the first Fresnel zone 30, and the lengths of an upper side 14Ba and a lower side 14Bb that are the sides in the horizontal direction are formed longer than the lengths of the left side 14Bc and the right side 14Bd.

FIG. 10 is a diagram illustrating angular dependence of received power according to the third embodiment. FIG. 10 illustrates the angular dependence of the received power that depends on a difference in the size (the length in the height direction×the length in the horizontal direction) of the radio wave refraction plate 14B.

It is assumed in the example illustrated in FIG. 10 that a linear distance between the transmission point of the radio wave and the radio wave refraction plate 14B is 50 m, a linear distance between the reception point of the radio wave and the radio wave refraction plate 14B is 2 m, and the frequency of the radio waves is 28 [GHz]. In this case, the radius of the first Fresnel zone 30 is 0.14 [m]. The received power is normalized as the received power when the radio wave refraction plate 14B is not installed.

FIG. 10 illustrates a waveform 121, a waveform 122, a waveform 123, and a waveform 124. The waveform 121 indicates angular dependence of received power of the radio wave refraction plate 14B of 0.6 m×0.6 m. The waveform 122 indicates angular dependence of received power of the radio wave refraction plate 14B of 0.3 m×0.6 m. The waveform 123 indicates angular dependence of received power of the radio wave refraction plate 14B of 0.3 m×0.3 m. The waveform 124 indicates angular dependence of received power of the radio wave refraction plate 14B of 0.3 m×0.05 m.

Referring to FIG. 10, as for the waveform 123, the normalized received power at 45 degrees of a refracting angle indicates the best characteristics. However, as for the waveform 122, the normalized received power in the widest range indicates 3 [dB]. That is, in the third embodiment, by making the length in the height direction of the radio wave refraction plate 14B twice the radius of the first Fresnel zone 30 and making the length thereof in the horizontal direction the length thereof in the height direction or more, high received power can be obtained over a wide range.

### Fourth Embodiment

A fourth embodiment is described. In the fourth embodiment, a plurality of radio wave refraction plates are disposed to improve received power.

In the fourth embodiment, a plurality of radio wave refraction plates including one or more refraction plates whose lengths in the horizontal direction of the radio wave refraction plates are in the range of ±25% of the length of twice the radius of the first Fresnel zone are used to improve the received power.

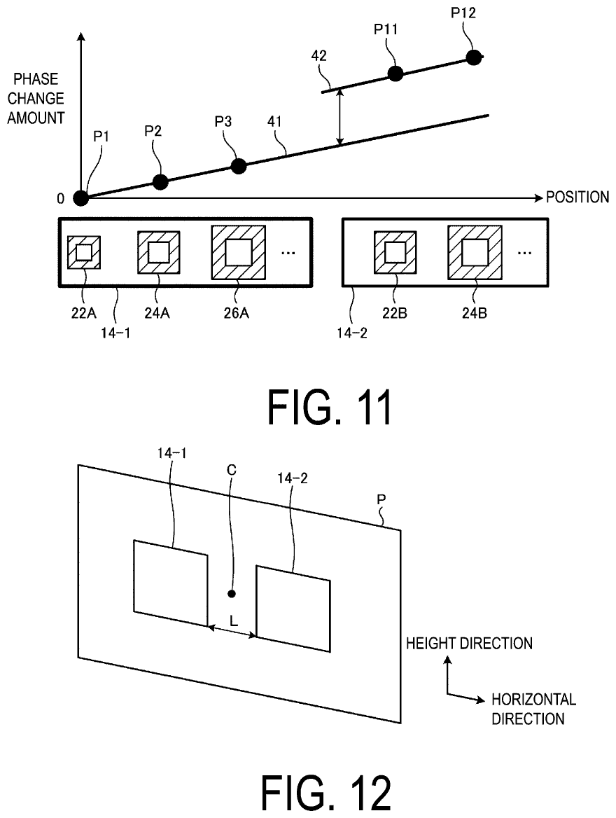

FIG. 11 is a diagram for explaining an installation method of a plurality of radio wave refraction plates according to the fourth embodiment. The example illustrated in FIG. 11 indicates an example where two refraction plates of a radio wave refraction plate 14-1 and a radio wave refraction plate 14-2 are disposed side by side.

The radio wave refraction plate 14-1 includes an element 22A, an element 24A, an element 26A, and . . . . The radio wave refraction plate 14-2 includes an element 22B, an element 24B, and . . . .

In the graph in FIG. 11, the horizontal axis indicates an installation position of the radio wave refraction plate 14, and the vertical axis indicates a phase change amount [degree]. A point P1 indicates the installation position and the phase change amount of the element 22A. A point P2 indicates the installation position and the phase change amount of the element 24A. A point P3 indicates the installation position and the phase change amount of the element 26A. A point P11 indicates the installation position and the phase change amount of the element 22B. A point P12 indicates the installation position and the phase change amount of the element 24B.

In the present embodiment, as illustrated in FIG. 11, the radio wave refraction plate 14-1 is installed such that the point P1 to the point P3 are on a straight line 41, and the radio wave refraction plate 14-2 is installed such that the point P11 and the point P12 are off the straight line 41.

In the example illustrated in FIG. 11, the radio wave refraction plate 14-2 is installed such that the point P11 and the point P12 are on a straight line 42. In other words, the radio wave refraction plate 14-1 and the radio wave refraction plate 14-2 are installed such that the phase change amounts become discontinuous. According to the fourth embodiment, by installing the radio wave refraction plate 14-2 off the straight line 41, received power of a refracted radio wave can be increased, and the characteristics can be further improved.

The arrow between the straight line 41 and the straight line 42 indicates a deviation between the phase change amounts of the straight line 41 and the straight line 42. By making the deviation between the phase change amounts of the straight line 41 and the straight line 42, for example, 180°, the characteristics can be further improved. Note that the deviation between the phase change amounts of the straight line 41 and the straight line 42 is not limited to 180°.

FIG. 12 is a schematic diagram illustrating a plurality of radio wave refraction plates according to the fourth embodiment. FIG. 12 illustrates that two radio wave refraction plates of the radio wave refraction plate 14-1 and the radio wave refraction plate 14-2 are disposed side by side. The radio wave refraction plate 14-1 and the radio wave refraction plate 14-2 are disposed side by side spaced a gap L apart from each other. In FIG. 12, a geometric center of the radio wave refraction plate 14-1 and the radio wave refraction plate 14-2 is defined as a geometric center O.

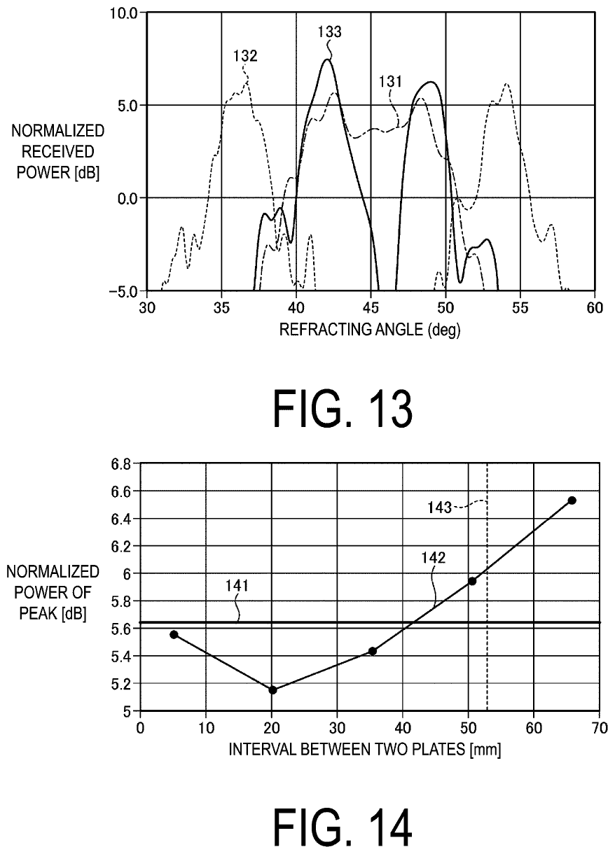

FIG. 13 is a diagram illustrating angular dependence of received power according to the fourth embodiment. FIG. 13 illustrates the angular dependence of the received power that depends on the difference in the length of the gap L between the radio wave refraction plate 14-1 and the radio wave refraction plate 14-2.

It is assumed in the example illustrated in FIG. 13 that a linear distance between the transmission point of the radio wave and the geometric center C is 50 m, a linear distance between the reception point of the radio wave and the geometric center C is 2 m, and the frequency of the radio waves is 28 [GHz]. In this case, the radius of the first Fresnel zone 30 is 0.14 [m]. The received power is normalized as the received power when the radio wave refraction plate 14-1 and the radio wave refraction plate 14-2 are not installed.

FIG. 13 illustrates a waveform 131, a waveform 132, and a waveform 133. The waveform 131 indicates angular dependence of received power of the one radio wave refraction plate 14 of 0.27 m×0.6 m. The waveform 132 indicates angular dependence of received power when the radio wave refraction plate 14-1 and the radio wave refraction plate 14-2 of 0.27 m×0.3 m are disposed spaced a gap of 0.5 m apart from each other. The waveform 133 indicates angular dependence of received power when the radio wave refraction plate 14-1 and the radio wave refraction plate 14-2 of 0.27 m×0.3 m are disposed spaced a gap of 0.01 m apart from each other. The waveform 132 and the waveform 133 indicate angular dependence of received power in an arrangement example where the phase change amounts of the radio wave refraction plate 14-1 and the radio wave refraction plate 14-2 become discontinuous.

Upon comparison between the waveform 131, the waveform 132, and the waveform 133, the waveform 132 and the waveform 133 indicate good normalized received power characteristics from a viewpoint of a peak value of the normalized received power. That is, in the fourth embodiment, by disposing the radio wave refraction plate 14-1 and the radio wave refraction plate 14-2 such that the phase change amounts of the radio wave refraction plate 14-1 and the radio wave refraction plate 14-2 become discontinuous, the peak value of the normalized received power can be improved.

### Fifth Embodiment

A fifth embodiment is described. In the fifth embodiment, when a plurality of radio wave refraction plates are disposed to improve received power, the radio wave refraction plates are disposed so as to satisfy two conditions.

The first condition is that the plurality of radio wave refraction plates are disposed side by side such that the coordinates of each element included in the plurality of radio wave refraction plates are projected in a linear shape onto a certain plane when an installation position of each element is plotted on the horizontal axis and the phase change amount [degree] is plotted on the vertical axis.

The second condition is that the radio wave refraction plate 14-1 and radio wave refraction plate 14-2 are installed such that the gap L between the plurality of adjacent radio wave refraction plate 14-1 and radio wave refraction plate 14-2 (see FIG. 12) is five times or more of the wavelength of the radio wave.

FIG. 14 is a diagram illustrating a relationship between gaps between the plurality of radio wave refraction plates and the received power according to the fifth embodiment. FIG. 14 illustrates a graph indicating a change in the normalized received power when the gap L between the radio wave refraction plate 14-1 and the radio wave refraction plate 14-2 (see FIG. 12) is changed. In FIG. 14, the horizontal axis indicates an interval [mm] between the two radio wave refraction plates, and the vertical axis indicates normalized received power [dB] at a time of a peak.

FIG. 14 illustrates a graph 141, a graph 142, and a straight line 143. The graph 141 indicates normalized received power of the one radio wave refraction plate 14 whose size in the height direction×horizontal direction is 0.27 m×0.6 m. The graph 142 indicates normalized received power when a gap between the two radio wave refraction plates 14 whose sizes in the height direction×horizontal direction are 0.27 m×0.3 m is changed. The straight line 143 indicates normalized received power at a time of a peak when an interval between the two radio wave refraction plates 14 is increased to an interval that is five times the wavelength of the received radio wave. As illustrated in FIG. 14, when the interval between the two radio wave refraction plates 14 is increased to the interval that is five times the wavelength of the received radio wave, the graph 142 exceeds the normalized received power at the time of the peak in the graph 141. That is, in the fifth embodiment, by making an interval between two radio wave refraction plates 14 five or more wavelengths, the characteristics of the normalized received power can be made better than that when one large radio wave refraction plate is disposed.

An embodiment of the present disclosure has been described above, but the present disclosure is not limited by the contents of the embodiment. Constituent elements described above include those that can be easily assumed by a person skilled in the art, those that are substantially identical to the constituent elements, and those within a so-called range of equivalency. The constituent elements described above can be combined as appropriate.

Various omissions, substitutions, or modifications of the constituent elements can be made without departing from the spirit of the above-described embodiment.

### REFERENCE SIGNS

1 Communication system
10 Base station
11 Obstacle
12 Terminal
14 Radio wave refraction plate
20 Substrate
22, 24, 26, 28 Element
30 First Fresnel zone
32 Second Fresnel zone
34 Third Fresnel zone
36 Fourth Fresnel zone

1. A radio wave control plate installed between a transmitter configured to transmit a radio wave and a receiver configured to receive the radio wave,
wherein a length in a first direction parallel to a refraction surface or a reflection surface of the radio wave and/or a length in a second direction perpendicular to the first direction in the radio wave control plate is from 75% to 125% of twice a radius of a circular region defined according to a positional relationship between the transmitter, the radio wave control plate, and the receiver.

2. The radio wave control plate according to claim 1, wherein, when a distance between the transmitter and a center of the radio wave control plate is set as dₜ, a distance between a center of the refraction surface or the reflection surface and the receiver is set as dᵣ, and a wavelength is set as λ, a radius r of the circular region satisfies following Equation (1-1).
$$\begin{matrix}[ Math 1 ] & \\ r = \sqrt{\frac{λ {d}_{t} {d}_{r}}{{d}_{t} + {d}_{r}}} & ( 1 - 1 )\end{matrix}$$

3. The radio wave control plate according to claim 1, wherein the length in the second direction is from 75% to 125% of twice the radius of the circular region, and the length in the first direction is longer than the length in the second direction.

4. The radio wave control plate according to claim 1, wherein the length in the first direction is from 75% to 125% of twice the radius of the circular region, and the length in the second direction is longer than the length in the first direction.

5. The radio wave control plate according to claim 1, wherein the first direction is a horizontal direction of the radio wave control plate, and the second direction is a height direction of the radio wave control plate.

6. A communication system comprising:
a transmitter configured to transmit a radio wave;
a plurality of radio wave control plates configured to refract or reflect the radio wave transmitted from the transmitter; and
a receiver configured to receive the radio wave refracted or reflected by the plurality of radio wave control plates,
wherein a length in a first direction parallel to a refraction surface or a reflection surface of the radio wave and/or a length in a second direction perpendicular to the first direction in each of the plurality of radio wave control plates is from 75% to 125% of twice a radius of a circular region defined according to a positional relationship between the transmitter, the plurality of radio wave control plates, and the receiver.

7. The communication system according to claim 6, wherein the plurality of radio wave control plates are installed such that, when coordinates of each of a plurality of elements comprised in each of the radio wave control plates are plotted on a graph indicating a position on a horizontal axis and a transmission phase on a vertical axis, the coordinates are not on a straight line.

8. The communication system according to claim 6, wherein the plurality of radio wave control plates are installed such that the plurality of radio wave control plates aligned side by side are installed spaced apart from each other with a gap that is five times or more of a wavelength of the radio wave.
